(19) United States
(12) Patent Application Publication
(10) Pub. No.: US 2008/0228813 A1
(43) Pub. Date: Sep. 18, 2008

(54) Trusted-referral systems and methods

(76) Inventors: Benjamin Weiss, Portola Valley, CA (US); Stephen Currie, Atlanta, GA (US)

Correspondence Address: SMITH FROHWEIN TEMPEL GREENLEE BLAHA, LLC, Two Ravinia Drive, Suite 700, ATLANTA, GA, 30346, US

(21) Appl. No.: 11/724,891

(22) Filed: Mar. 16, 2007

(51) Int. Cl. G06F 17/30

(52) U.S. Cl. 707/103 X

(57) ABSTRACT

A system for providing trusted-referrals includes a database of member-assessments. The member-assessments are related to user-appraisals that are provided by members of a trusted network of users. The system receives a referral-request from a member of the trusted network, and a module creates a trusted-referral using at least a portion of at least one member-assessment. The system provides the trusted-referral to member that requested the trusted-referral.

### TECHNICAL FIELD

The present invention is generally related to providing a referral and, more particularly, is related to a providing a trusted-referral to a member of a network.

### BACKGROUND OF THE INVENTION

Today, many people use the Internet as a research tool for determining, pricing of commercial goods and services, the reliability of goods, and other things. Sometimes, users of the Internet may try to find reviews on a particular good or service or on a class of goods. The users might look for reviews using a conventional search engine.

A problem associated with doing an internet search for a review is that today almost any person can post his or her review, or assessment, on virtually anything and everything. Thus, an internet search for a review, or assessment, may provide the searcher with many reviews, or assessments, but the searcher may have no way of knowing the value of the reviews, or assessments. Thus, a heretofore unaddressed need exists in the industry to address the aforementioned deficiencies and inadequacies.

### SUMMARY OF THE INVENTION

Embodiments of the present invention provide a system and method for providing trusted-referrals. Briefly described, in architecture, one embodiment of the system, among others, can be implemented as follows. A system that responds to referral-requests includes a database, an input device, and a referral module. The database includes member-assessments. The member-assessments are provided to the system from a plurality of members of a trusted network. The input device receives a referral-request from a given member of the trusted network, and the referral module creates a trusted-referral using at least a portion of the referral-request and at least a portion of at least one member-assessment. An output device provides the trusted-referral to the given member of the trusted network.

The present invention can also be viewed as providing methods for providing referrals. In this regard, one embodiment of such a method, among others, can be broadly summarized by the following steps: receiving, from a given member of a trusted network having a plurality of members, a referral-request; receiving, from the members of the trusted network, user-appraisals; creating a trusted referral using at least a portion of the referral-request and information related to the user-appraisals from the members of the trusted network; and providing the given member with the trusted referral

Other systems, methods, features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 illustrates multiple social networks, which are comprised of users, and a trusted-referral system.

FIG. 2 illustrates non-limiting embodiments of a network communication device used to communicate with the trusted-referral system of FIG. 1.

FIG. 3 is a block diagram of a network communication device.

FIG. 4 is a block diagram of a user-assessment window.

FIG. 5 is a block diagram of a referral-request window.

FIG. 6 is a block diagram of a message.

FIG. 7 is a block diagram of the trusted-referral system.

FIG. 8 is a flow chart of a process for providing trusted-referrals.

### DETAILED DESCRIPTION OF THE PREFERRED EMBODIMENT

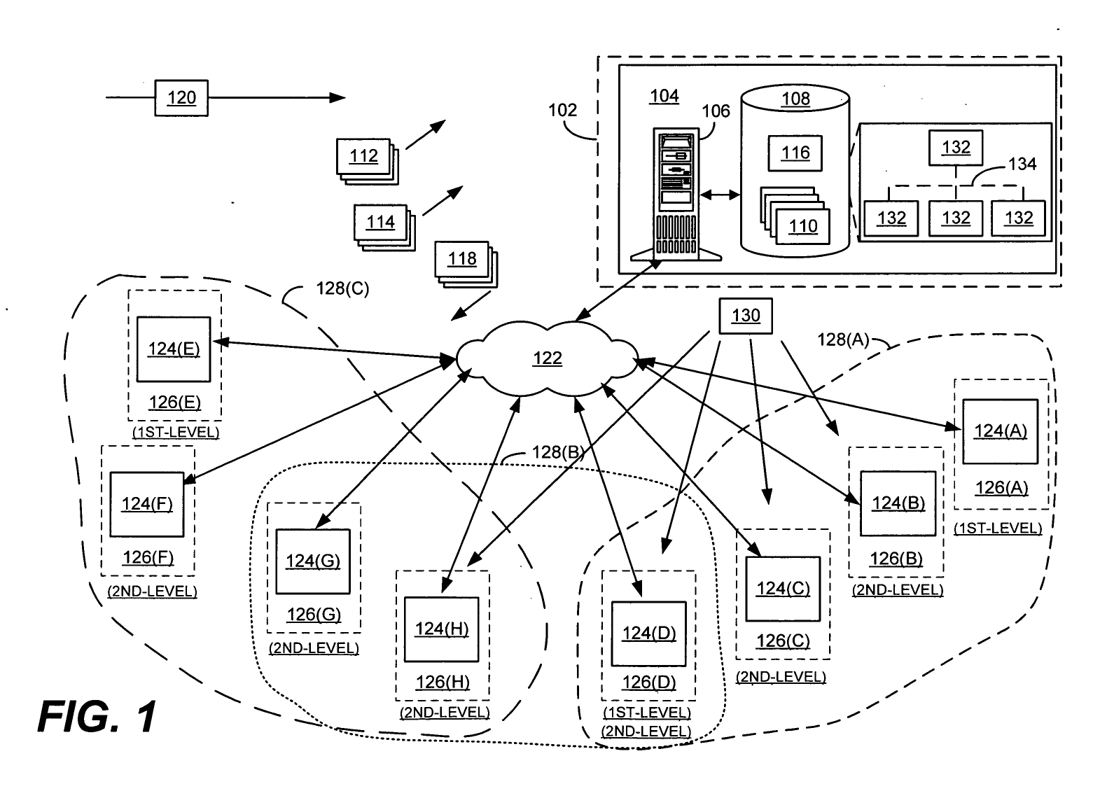

Referring to FIG. 1, a referral provider 102 may use a referral system 104 to provide, among other things, trusted-referrals 118, which may be related to commerce such as goods and services. Typically, the referral system 104 includes a server 106 and a database 108, which has a plurality of member-assessments 110 stored therein. Typically, the server 106 is configured to receive user-appraisal messages 112 from users of the referral system 104. The user-appraisal messages 112 may be related to something tangible such as, but not limited to, a good or may be related to something intangible such as, but not limited to, a service. For example, a given user-appraisal message 112 may be related to a good such as a computer, or a service such as lawn maintenance, or a service such as private or public education. In generality, any given user-appraisal message 112 may be related to anything that a user has appraised. For example, a user-appraisal message 112 may include information related to a review of a movie, restaurant, musical band, etc.

The server 106 processes user-appraisal messages 112 and creates member-assessments 110 from the processed user-appraisal message 112 and stores member-assessments 110 in the database 108. In some embodiments, the referral system 104 may include a second server or other device for receiving and/or processing user-appraisal messages 112. In addition, a second server or other device may be used for, among other things, managing the database 108.

Among other things, the referral system 104 receives referral-requests 114. Typically, the referral-requests 114 are processed by the server 106. However, in some embodiments, a second server and/or another device may process referral-requests. Typically, a given referral-request 114 is regarding information related to a commercial good and/or service. However, referral-requests may be regarding information related to things beyond commercial goods and/or services. As a non-limiting example, a referral-request may be regarding information related to a movie, a play, a song, public/private school, etc. For the purposes of this disclosure, referral-requests are not limited to being related to commercial goods and/or services. Rather, referral-requests may be related to anything, tangible or intangible, for which a person may desire a referral.

In response to receiving one of the referral-requests 114, the server 106 may use one or more of the member-assessments 110 stored in the database 106 to create a social network appraisal 116. As will be described in detail hereinbelow, the server 106 may aggregate content from more than one of the member-assessments 110 to create the social network appraisal 116. Furthermore, in response to receiving the referral-requests 114, the server 106 may provide trusted-referrals 118. Typically, a given trusted-referral 118 is related to information regarding a good and/or service. However, trusted-referrals need not be limited to information regarding goods and/or services and may include, but are not limited to, reviews, critiques, etc. Trusted-referrals may be related to anything, tangible or intangible, for which a person may desire a referral.

The referral provider 102 may receive compensation and/or payment and/or credit 120 for, among other things, providing trusted-referrals, and typically, the compensation/payment/credit 120 may be from providers of goods and/or services. The compensation/payment/credit 120 may be based upon the number of trusted-referrals related to a specific good or service. Alternatively, the compensation/ payment/credit 120 may be in accordance with a predetermined scheme such as, but not limited to, a fixed rate.

In one embodiment, trusted-referrals 118 may include one or more of, but not limited to, an advertisement and/or a hyperlink to a web page, etc., which may include content that is related to information included in a given trusted-referral. The referral service provider 102 may receive compensation/payment/credit for providing the advertisement and/or the hyperlink to a web page, etc. As a non-limiting example, a given trusted-referral 118 may include information related to a specific athletic shoe and an advertisement and/or a hyperlink to a web page. The content included in the advertisement and/or the hyperlinked web page may include content for the specific athletic shoe, or for a different athletic shoe from the same manufacture, or for a different athletic shoe from a different manufacture, or an activity related to the athletic shoe (e.g. a basketball tournament, track and field meet, etc.). Thus, in some embodiments, the service provider 102 may receive compensation/payment/credit 120 for, among other things, providing advertisements and/or hyperlinks to web pages, etc.

The referral system 104 is in two way communication with a distributed network 122 such as the Internet. Through the distributed network 122, the referral system is in two way communication with a plurality of network communication devices 124(A)-124(H). The network communication devices 124(A)-124(H) are operated by users 126(A)-126(H), respectively. Users 126(A)-126(D) comprise a first social network 128(A). Similarly, users 126(D), 126(G), and 126(H) comprise a second social network 128(B); and users 126(E)-126(H) comprise a third social network 128(C). For the purposes of this disclosure, a social network is comprised of a first-level member and at least one second level member, where the first level member may be the originating member of a given social network, i.e., the person who started the given social network, and the second level members are people that have joined the given social network. A person can be concurrently the first-level member of his/her social network and a second-level member of another person's social network. For example, user 126(D) is the first-level member of the social network 128(B) and a second level-member of the social network 128(A).

The users 126(A)-126(H) communicate with the referral system 104 using their respective network communication devices 124(A)-124(H). The users 126(A)-126(H) may use their respective network communication devices 124(A)-124(H) to, among other things, generate user-appraisal messages 112 and referral-requests 114, both of which may then be provided to the referral system 104 via the distributed network 122. The users 126(A)-126(H) may use their respective network communication devices 124(A)-124(H) to receive trusted-referrals 118.

In some embodiments, the referral system 104 may also provide social network services, and in that case, the server 106 may include hardware, software, and/or firmware for providing the social network services including registering users in an electronic social network.

The users 126(A)-126(H) may use their respective network devices 124(A)-124(H) to access the referral system 104 and register with and/or create a social network at the referral system 104. Users may provide profiles, member-profiles 132, which are stored in the database 108. The referral system 104 may link several member-profiles 132 into an electronic social network 134.

In some embodiments, the referral system 104 may be configured to provide “pop-up windows,” which display content on a user's network communication device. The content in the “pop-up windows” may be related to information included in a given trusted-referral. The service provider 102 may receive compensation/payment/credit 120 for, among other things, providing the “pop-up windows.”

In some embodiments, users 126(A)-126(H) of the referral system 104 may receive a form of compensation 130 from the referral system. Typically, the compensation 130 is provided to users 126(A)-126(H) as an incentive for providing user-appraisal messages 112. As non-limiting examples, the compensation 130 may include cash, credit, discount points, rebates, program points such as, but not limited to, frequent flyer mileage, etc.

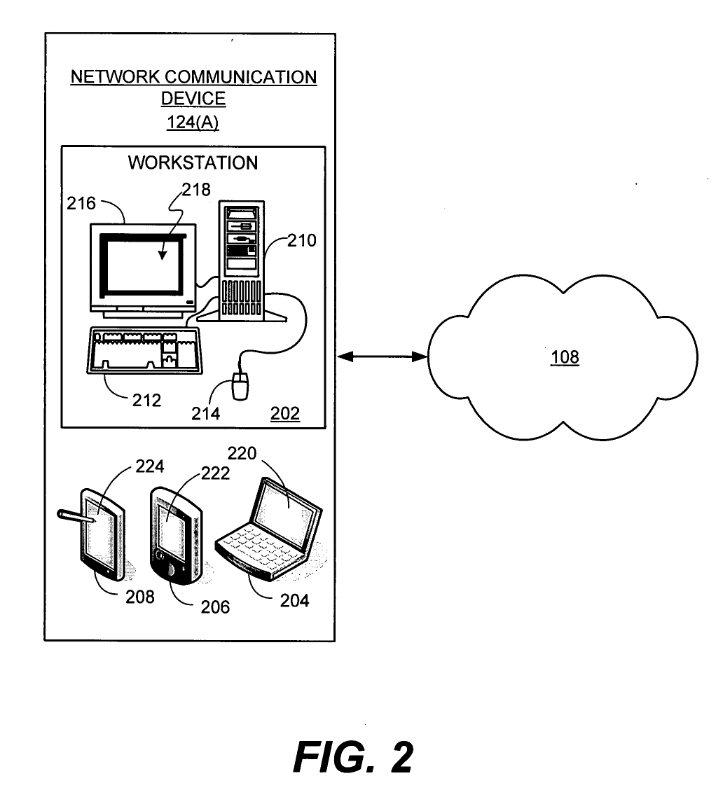

FIG. 2 illustrates various embodiments of the network communication device 124(A). Embodiments of the other network communication devices 124(B)-124(H) will generally include embodiments illustrated in FIG. 2. The network communication device 124(A) can comprise a range of devices including workstation 202, laptop computer 204, personal digital assistant 206 and tablet computer 208. Workstation 202 comprises computer 210, and various input/output devices such as keyboard 212, mouse 214 and monitor 216. Each example of the network communication device 124(A) comprises a respective display for presenting, among other things, a graphical-user interface and content to the user 126(A) of the network-communication device 124(A). Monitor 216 includes a cathode-ray tube, at which content 218 is displayed. Laptop computer 204 includes a thin-film transistor active matrix display 220. Personal digital assistant 206 and tablet computer 208 include liquid crystal display 222 and liquid crystal display 224, respectively. In addition to having a display device, each of the user devices includes one or more input/output mechanisms that permit an operator to, among other things, enter commands on a graphical-user interface, send requests to distributed network 122, and display content from the distributed network 122.

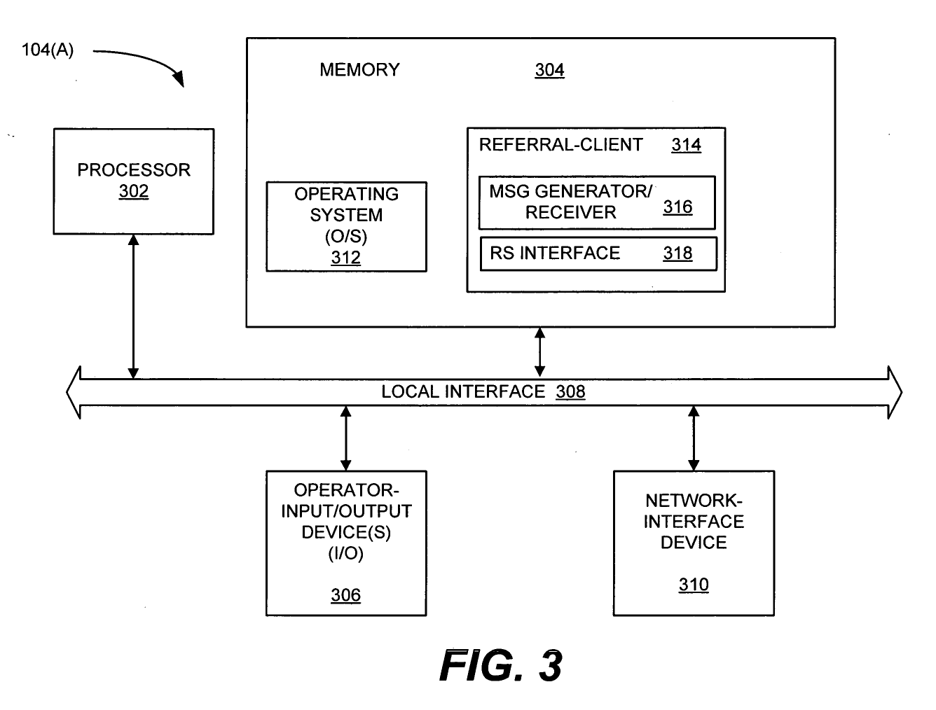

FIG. 3 is a schematic diagram illustrating an embodiment of the network communication device 124(A) of FIGS. 1 and 2. Generally, in terms of hardware architecture, as shown in FIG. 3, network communication device 124(A) includes processor 302, memory 304 and one or more user input and/or output (I/O) devices 306 (or peripherals) that are communicatively coupled via a local interface 308. The local interface 308 can be, for example but not limited to, one or more buses or other wired or wireless connections, as is known in the art. The local interface 308 may have additional elements, which are omitted for simplicity, such as controllers, buffers (caches), drivers, repeaters, and receivers, to enable communications. Further, the local interface 308 may include address, control, and/or data connections to enable appropriate communications among the aforementioned components.

Processor 302 is a hardware device for executing software, particularly that stored in memory 304. The processor 302 can be any device for executing software instructions. The memory 304 can include any one or combination of volatile memory elements (e.g., RAM, such as DRAM, SRAM, SDRAM, etc.) and nonvolatile memory elements (e.g., ROM, flash memory, etc.). Moreover, the memory 304 may incorporate electronic, magnetic, optical, and/or other types of storage media. Note that the memory 304 can have a distributed architecture, where various components are situated remote from one another, but can be accessed by the processor 302.

The user I/O devices 306 may include input devices, for example but not limited to, a keyboard, mouse, scanner, microphone, a touch sensitive display etc. Furthermore, the user I/O devices 306 may also include output devices, for example but not limited to, a printer, display, etc. I/O devices may further include devices that communicate both inputs and outputs, for instance but not limited to, a modulator/demodulator (modem; for accessing another device, system, or network), a radio frequency (RF) or other transceiver, a telephonic interface, a bridge, a router, etc. One or more of these communication devices may be included in a network interface device 310, which enables network communication device 124(A) to communicate with the distributed network 122.

Software stored in memory 304 may include one or more separate programs, each one of which comprises an ordered listing of executable instructions for implementing logical functions. In the example of FIG. 3, the software in the memory 304 includes operating system 312 and referral-client module 314. Among other things, operating system 312 essentially controls the execution of referral-client module 314 and provides scheduling, input-output control, file and data management, memory management, and communication control and related services.

Referral-client module 314 may be a source program, executable program (object code), script, or any other entity comprising a set of instructions to be performed. When implemented as a source program, referral-client module 314 is translated via a compiler, assembler, interpreter, or the like, which may or may not be included within the memory 304, so as to operate properly in connection with the O/S 312. Furthermore, referral-client module 314 can be written in one or more object oriented programming languages, which have classes of data and methods, or procedure programming languages, which have routines, subroutines, and/or functions.

The referral-client module 314 includes a message generator/receiver module 316 and a referral system (RS) interface module 318. The message generator/receiver module 316 generates messages such as member-assessment messages 112 and referral-request messages 114. The message generator/receiver module 316 also receives messages such as referral messages 118. Among other things, the message generator/receiver module 316 may include logic for addressing messages, displaying messages, and editing messages. In some embodiments, the message generator/receiver module 316 may be embodied in an email application.

The RS interface module 318 may be configured to include logic that enables the network communication device 124(A) to communicate with the referral system 104. Among other things, the RS interface module 318 may include logic for accessing the referral system 104, which may include logging into the referral system 104, providing information such as member-assessment messages 112 and referral-request messages 118, editing member-profiles, managing a social network, joining a social network, quitting a social, etc. In some embodiments, the RS interface module 318 may be embodied in a web browser. In some embodiments, the RS interface module 318 may include logic fro displaying, among other things, pop-up windows provided by the referral system 104.

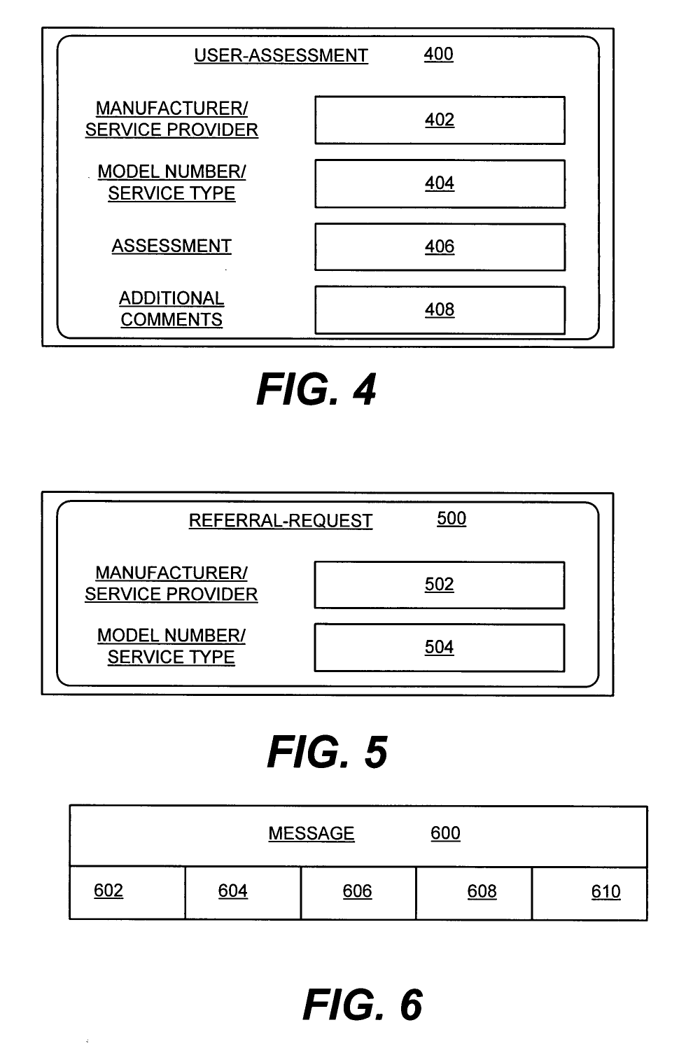

FIG. 4 is a diagram of an exemplary user assessment window 400 that may be displayed on the monitor 216. The user assessment window 400 may be generated by modules of the referral-client 314. Typically, the message generator/receiver module 316 generates the user assessment window 400. In some embodiments, the user assessment window 400 may be used for assessments of both goods and services. In other embodiments, the referral-client 314 may generate different windows depending upon whether the user is assessing a good or a service. The user assessment window 400 illustrated in FIG. 4 includes four input boxes 402, 404, 406, and 408. In some embodiments, the user assessment window 400 may include more or fewer input boxes. In addition, in some embodiments, one or more of the input boxes may include pull down tabs. The input box 402 is a top-level identifier where, in a non-limiting example, the user may input the name of the manufacturer/service provider being assessed. The input box 404 is second level identifier in which the user may input the model number of a good being assessed or the service being assessed. As a non-limiting example, the user may enter the name of a telephone service provider in input box 402 and may enter Digital Subscriber Line (DSL) in input box 404 as the service being assessed. As another non-limiting example, the user may enter the name of an automobile manufacturer in input box 402 and the name of a car in input box 404. In some embodiments, more input boxes may be provided to further specify the subject of the assessment, whether the subject is tangible or intangible, and/or to further specify features of the assessment subject. Thus, in a non-limiting example, a user might specify a car by its name and further specify features such as convertible/hardtop, engine size, accessories, etc. The input box 406 is provided to allow the user to input the user's overall-assessment. In some embodiments, overall-assessments may be standardized, e.g., a rating between 1-10. The user may use input box 408 to provide non-standardized assessments, e.g., the user's individual comments/review. For example, the user may use input box 208 to enter his or her reasoning behind the overall-assessment and/or assessments regarding aspects of the thing (tangible or intangible) being assessed. For example, in the case of a car, the user may provide an overall-assessment in input box 406, and then provide an assessment for the power train of the car and/or for the handling of the car, etc. Similarly, in the case of telephone service provider, the user may provide an overall-assessment of a DSL service from the telephone service provider and then in input box 408 provide assessments for, among other things, call support, reliability, etc.

FIG. 5 is a diagram of an exemplary user referral-request window 500 that may be displayed on the monitor 216. The user referral-request window 500 may be generated by modules of the referral-client 314. Typically, the message generator/receiver module 316 generates the user referral-request window 500. In some embodiments, the user referral-request window 500 may be used for requesting a trusted-referral for both goods and services. In other embodiments, the referral-client 314 may generate different windows depending upon whether the user is requesting a trusted-referral for either a good or a service.

The user referral-request window 500 illustrated in FIG. 5 includes two input boxes 502 and 504. In some embodiments, the user referral-request window 500 may include more or fewer input boxes. In addition, in some embodiments, one or more of the input boxes may include pull down tabs. The input box 502 is a top-level identifier where the user may input the name of a manufacturer/service provider. The input box 504 is second level identifier in which the user may input a model number of a good or a service. As a non-limiting example, the user may enter the name of a telephone service provider in input box 502 and may enter Digital Subscriber Line (DSL) in input box 504. As another non-limiting example, the user may enter the name of an automobile manufacturer in input box 502 and the name of a car in input box 504. In some embodiments, more input boxes may be provided to further specify the subject of the trusted-referral-request. Thus, in a non-limiting example, a user might specify a car by its name and further specify features such as convertible/hardtop, engine size, accessories, etc.

It should be remembered that user assessment window 400 and user referral-request window 500 are merely exemplary windows. In some embodiments, user assessment window 400 and user referral-request window 500 may include fewer or more input windows. As a non-limiting example, a user assessment window may include an input box for a category identifier that broadly defines the assessment subject. Non-limiting examples of category identifiers include “computer,” “laptop computer,” “automobile,” “compact automobile,” “hybrid automobile,” “babysitter,” “day care provider,” etc. Similarly, a user referral window may include an input box for a category identifier which broadly defines the referral-request subject.

Further, in some embodiments, user assessment window 400 and user referral-request window 500 may include menus and/or pull down tabs. The menus and/or pull down tabs may be used to define the tangible or intangible thing being assessed and to define the tangible or intangible thing for which a trusted-referral is being requested.

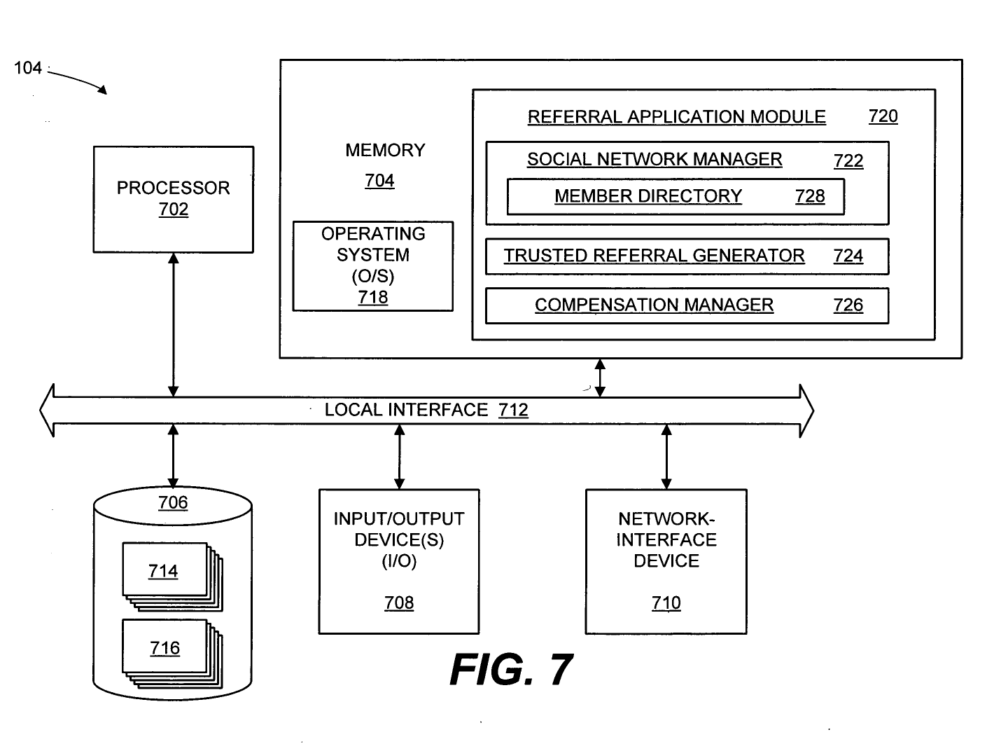

FIG. 6 is a schematic diagram of a message 600. The message 600 may be a user-appraisal message 112 and/or may be a referral-request message 114. The message 600 includes a recipient address field 602. The recipient address field 602 carries an identifier associated with the referral system 104. The recipient address field 602 may include, but is not limited to, an email address and IP address. The message 600 also includes a sender address field 604. The sender address field 604 may include, but is not limited to, an email address associated with the sender and an IP address associated with one of the network communication devices.

In some embodiments, the message 600 may include a message-type identifier 606 and may include a member/social-network identifier 608. The message-type identifier 606 may be a flag which may be set to a first value for identifying the message 600 as comprising a user-appraisal message 112 and may be set to a second value for identifying the message 600 as comprising a referral-request message 114. The member/social-network identifier 608 may be used to specify a given member of a social network and/or used to specify a given social network or multiple social networks.

The message 600 also includes a payload 610. The payload 610 may include content such as information related to an appraisal and/or information related to a referral-request. If the message type 606 is set to identify the message 600 as a user-appraisal message 112, the payload 610 may include information from the user assessment window 400 such as, but not limited to, information related to a thing (tangible or intangible) being assessed and information related to an assessment. If the message type 606 is set to identify the message 600 as a referral-request message 114, the payload 610 may include information from the user referral-request window 500 such as, but not limited to, information related to a referral for a thing (tangible or intangible).

FIG. 7 is a schematic diagram illustrating an embodiment of the referral system 104. Generally, in terms of hardware architecture, as shown in FIG. 7, the referral system 104 includes processor 702, memory 704, database 706, one or more operator input and/or output (I/O) devices 708 (or peripherals), and one or more network-interface devices 710, all of which are communicatively coupled via a local interface 712.

The local interface 712 can be, for example but not limited to, one or more buses or other wired or wireless connections, as is known in the art. The local interface 712 may have additional elements, which are omitted for simplicity, such as controllers, buffers (caches), drivers, repeaters, and receivers, to enable communications. Further, the local interface 710 may include address, control, and/or data connections to enable appropriate communications among the aforementioned components.

Processor 702 is a hardware device for executing software, particularly that stored in memory 704. The processor 702 can be any custom made or commercially available processor, a central processing unit (CPU), an auxiliary processor among several processors associated with the referral system, a semiconductor based microprocessor (in the form of a microchip or chip set), or generally any device for executing software instructions.

The memory 704 and/or database 706 can include any one or combination of volatile memory elements (e.g., random-access memory (RAM), such as dynamic random-access memory (DRAM), static random-access memory (SRAM), synchronous dynamic random-access memory (SDRAM), etc.) and nonvolatile memory elements (e.g., read-only memory (ROM), hard drive, tape, compact disc read-only memory (CDROM), etc.). Moreover, the memory 704 and/or database 706 may incorporate electronic, magnetic, optical, and/or other types of storage media. Note that the memory 704 and/or database 706 can have a distributed architecture, where various components are situated remote from one another, but can be accessed by the processor 702. The database 706 includes a plurality of member-assessments 714 and a plurality of member-profiles 716.

Software in memory 704 may include one or more separate programs, each of which comprises an ordered listing of executable instructions for implementing logical functions. In the example of FIG. 7, the software in the memory 704 includes operating system 718 and referral application module 720. The operating system 718 essentially controls the execution of computer programs and provides scheduling, input-output control, file and data management, memory management, and communication control and related services.

I/O devices 708 may include input devices, for example but not limited to, a keyboard, mouse, scanner, microphone, etc. Furthermore, I/O devices 708 may also include output devices, for example but not limited to, a printer, display, etc. I/O devices 308 may further include devices that communicate both inputs and outputs, for instance but not limited to, a modulator/demodulator (modem; for accessing another device, system, or network), a radio frequency (RF) or other transceiver, a telephonic interface, a bridge, a router, etc. One or more of these communication devices may be included in network-interface device 710, which enables referral application module 720 to communicate with network coupled devices. I/O devices 708 enable a local operator to configure programs and/or data associated with referral application module 720.

When referral application module 720 is in operation, the processor 702 is configured to, among other things, execute software stored within the memory 704, to communicate data to and from the memory 704, enroll users, manage social networks, receive user-appraisal messages 112 and referral-request messages 114, manage the member-assessments 714, manage the member-profiles 716, provide referral-messages 118, and to generally control operations of the referral application module 720 pursuant to the software. The referral application module 720 and the O/S 718, in whole or in part, but typically the latter, are read by the processor 702, perhaps buffered within the processor 702, and then executed.

When the referral application module 720 is implemented in software, as is shown in FIG. 7, it should be noted that the referral application module 720 can be stored on any computer-readable medium for use by or in connection with any computer related system or method. In the context of this document, a “computer-readable medium” is an electronic, magnetic, optical, or other physical device or means that can contain or store a computer program for use by or in connection with a computer related system or method. The referral application module 720 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

In the context of this document, a “computer-readable medium” can be any means that can store, communicate, propagate, or transport the program for use by or in connection with the instruction execution system, apparatus, or device. The computer-readable medium can be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random-access memory (RAM) (electronic), a read-only memory (ROM) (electronic), an erasable programmable read-only memory (EPROM), an electrically erasable programmable read-only memory (EEPROM), or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

In an alternative embodiment, where one or more modules such as the referral application module 720 are implemented in hardware the referral application module 720 can implemented with any or a combination of the following technologies, which are each well known in the art: a discrete logic circuit(s) having logic gates for implementing logic functions upon data signals, an application-specific integrated circuit (ASIC) having appropriate combinational logic gates, a programmable gate array(s) (PGA), a field programmable gate array (FPGA), etc.

In some embodiments, the referral application module 720 includes a social network manager module 722, a trusted-referral generator module 724, and a compensation manager 726. Among other things, the social network manager module 722 includes logic for enabling persons such as, but not limited to, users 126(A), 126(D), and 126(E) to create and electronic social networks 134. The social network manager 722 may include logic for creating and maintaining a member directory 728 and for creating and maintaining member-profiles 716. The member directory 728 may be used to associate the members of a given social network. Each member-profile 716 is associated with a specific user. A user's member-profile includes information that identifies the specific user and other information such as characteristics of the user. The member directory 728 associates users to the social network or social networks to which the users belong.

Among other things, the referral application module 722 is configured to receive message 600 and use the message-type identifier 606 to determine whether the message 600 is a referral-request 114 or a user-appraisal 112. Upon receiving a user-appraisal 114, the referral application module 720 may associate the user-appraisal 114 with a specific user or with a specific social-network or with multiple social-networks. The referral application module 720 may information included in the user-appraisal 114 to identify the specific user or the specific social-network or the multiple social-networks. For example, the referral application module 720 may use information in the sender address field 604 or the member/social-network identifier field 608 for identifying the specific user and/or the specific social-network(s).

The referral application module 722 may be configured to retrieve a specific member-assessment 714 from the database 706 based upon the identified specific user and modify the retrieved member-assessment 714. The referral application module 722 modifies the retrieved member-assessment 714 to include information carried in the user-appraisal 114.

In some embodiments, the referral application module 722 may be configured to maintain social-network assessments (not shown). A social-network assessment is associated with a given electronic social-network. The members of the given electronic social-network send user-appraisals 114, and the referral application module may include information from the received user-appraisals in the social-network assessment.

When the referral application module 722 identifies the message 600 as a referral-request 114, the referral application module 722 may provide the message 600 to the trusted-referral generator module 724, which then generates a trusted-referral 118. The trusted-referral generator module 724 reads the payload 610 and determines the referral subject matter. In some embodiments, the trusted-referral generator 724 may determine that the sender of the referral message belongs to a particular electronic social-network. The trusted-referral generator 724 may identify the sender of the referral message and then use the member directory 728 to determine the sender's particular electronic social-network. Alternatively, the referral message may include a social-network identifier carried in field 608 of the message 600, and identify a particular electronic social-network accordingly.

Upon having identified a particular electronic social-network, the trusted-referral generator may then search the member-assessments 714 for the members of the particular electronic social-network for assessments corresponding to the referral subject. The trusted-referral generator may then generate a trusted-referral based upon assessments by members of the particular electronic social-network and provide the trusted-referral to the sender of the referral-request. Typically, the trusted-referral generator will identify the particular electronic social-network that has the sender of referral-request as the first level member.

In some embodiments, the sender of the referral-request may specify particular members of a given social-network. The searched member-assessments might be limited to those member-assessments belonging to the specified members, or alternatively, the member-assessments belonging to those specified members might be excluded from the search. The sender might specify the particular members by interfacing with the referral system 104. Typically, the referral system 104 may provide web pages that enable users to interface with the referral system 104. In addition to specifying particular members, the sender of the referral-request may provide weighting factors that may be used in the generation of a trusted-referral such that member-assessments from one or more members are weighted more heavily than member-assessments from another member. In one embodiment, the referral-request may include information identifying particular members whose member-assessments are to be included or excluded from a trusted-referral and may include member weighting information. In some embodiments, members whose member-assessments are to be “effectively” excluded may have a predetermined weighting factor such as zero (0) such that those member-assessments do not “effectively” appear in the trusted-referral.

Among other things, the compensation manager 726 may be configured to provide advertisements, which are related to the subject of a referral-request, to the sender of the referral-request. The advertisements might be in the form of a “pop-up” window, a hyperlink in the trusted-referral, or other content in the trusted-referral. The compensation manager 726 may be configured to bill entities for which advertisements have been provided and provide accounting of received compensation.

In some embodiments, the compensation manager 726 may provide compensation to users who have provided user-appraisals. Typically, the compensation manager 726 determines which users had member-assessments that were used in a trusted-referral and compensates those users.

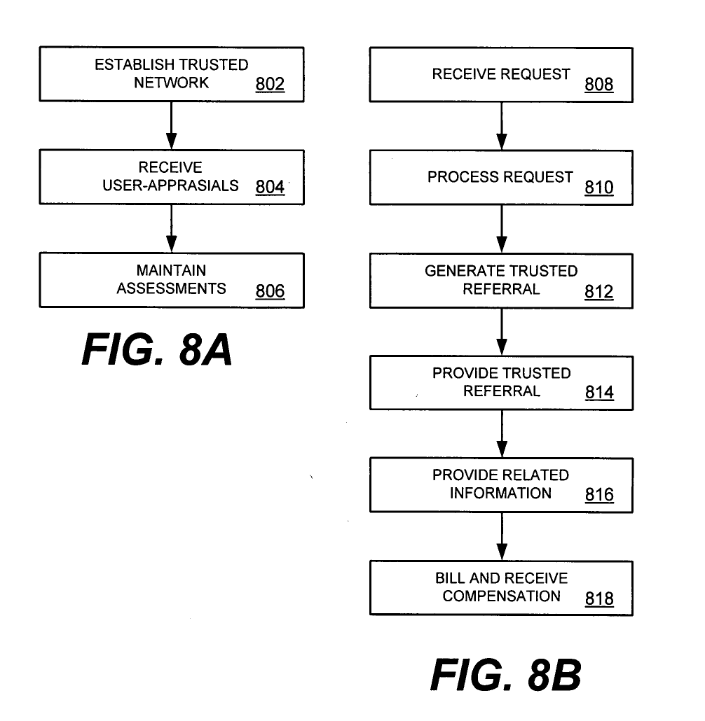

Referring to FIGS. 8A and 8B, which are exemplary flow charts illustrating steps for providing trusted-referrals; a trusted network is established in step 802. Typically, a trusted network is comprised of a social network. A first level member invites other people to join his or her social network. Those people who join his or her social network may comprise his or her trusted network.

In step 804, user-appraisals are received. Typically, a user-appraisal includes information such as an assessment subject that identifies the subject matter of the thing (tangible or intangible) that is being assessed and an assessment and information for identifying a sender and/or an electronic social-network.

Information is parsed from received user-assessments. The parsed information is then included in member-assessments and/or social-network assessments. In step 806, a database having member-assessments and/or social-network assessments is maintained.

In step 808, a trusted-referral-request is received. The trusted-referral-request may include information identifying the sender of the trusted-referral-request and/or information identifying one or more trusted networks such as social-networks.

In step 810, the trusted-referral-request is processed. Processing the trusted-referral-request normally includes determining the subject of the referral and identifying at least one trusted network or social-network. In some embodiments, the sender of the trusted-referral-request is first identified and then the social-network (or social-networks) to which the sender is a member is identified. Normally, the social-network in which the sender is the first-level member is used as the trusted network.

In step 812, a trusted-referral is generated based upon the identified trusted network and the trusted-referral-request. Typically, a search of member-assessments is performed based upon the referral subject. Normally, the member-assessments that are searched are limited to those belonging to the identified trusted network. In some embodiments, users whose member-assessments that have content that is used in the trusted-referral may be identified. The identified users may receive compensation for having provided user-assessments.

In some embodiments, the trusted-referral is generated based upon a trusted network appraisal (or social network appraisal 116). When user-appraisals are received, the user-appraisals are aggregated into “trusted network appraisals” or “social network appraisals,” based upon which trusted networks (or social networks) the senders of the user-appraisals belonged. The trusted network appraisal may be considered an aggregation of the user-appraisals from members of the trusted network.

In step 814, a trusted-referral is sent to the sender of the referral-request. The trusted-referral contains an assessment that is related to the referral subject of the referral-request. The assessment is based upon member-assessments belonging to a trusted network.

In step 816, information related to the referral-request may be provided to the sender of the referral-request. Typically, the related information may be an advertisement. In the case where the referral subject is for a specific good or specific service, the advertisement may be a different good or service.

In step 818, an entity is billed for the advertisement provided to the sender of the referral-request and compensation is received. The entity that is billed may be a manufacturer, distributor, retailer, service provider, etc. The billed entity may offer/sell/provide the referral subject or may offer/sell/provide a competing referral subject.

Any process descriptions or blocks in flow charts should be understood as representing modules, segments, or portions of code which include one or more executable instructions for implementing specific logical functions or steps in the process, and alternate implementations are included within the scope of the preferred embodiment of the present invention in which functions may be executed out of order from that shown or discussed, including substantially concurrently or in reverse order, depending on the functionality involved, as would be understood by those reasonably skilled in the art of the present invention.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

Therefore, having thus described the invention, at least the following is claimed:

1. A method of providing referrals, the method comprising the steps of:
receiving, from a given member of a trusted network having a plurality of members, a referral-request;
receiving, from the members of the trusted network, user-appraisals;
creating a trusted-referral using at least a portion of the referral-request and information related to the user-appraisals from the members of the trusted network; and
providing the given member with the trusted-referral.

2. The method of claim 1, further including the step of:
providing the members of the trusted network with compensation for the received appraisals.

3. The method of claim 2, wherein only the members who receive compensation are the members who provided information used in the creation of the trusted-referral.

4. The method of claim 2, wherein in response to receiving from a particular member of the trusted network one user-appraisal, the particular member is compensated.

5. The method of claim 1, further including the steps of:
creating member-assessments from at least a portion of the received user-appraisals, wherein at least a portion of at least one member-assessment is used in the creation of the trusted-referral; and
storing the member-assessments.

6. The method of claim 5, further including the step of:
restricting the creation of the trusted-referral to include member-assessments from only a subset of the members of the trusted network, wherein the number of members in the subset of the trusted network is less than the total number of members in the trusted network.

7. The method of claim 6, wherein the given member is restricted from subset of the trusted network.

8. The method of claim 6, further including the steps of:
receiving, from the given user, a member-restrictor; and
using at least the member-restrictor to determine the subset of members of the trusted network.

9. The method of claim 5, further including the steps of:
applying a first weight factor to a first member-assessment, wherein the first member-assessment is associated with a first member of the trusted network; and
applying a second weight factor to a second member-assessment, wherein the second member-assessment is associated with a second member of the trusted network.

10. The method of claim 9, further including the step of:
enabling the given member to set at least one weight factor.

11. The method of claim 5, wherein the member-assessments are related to an instrument of commerce comprising goods and services.

12. The method of claim 11, further including the step of:
receiving compensation for providing the referral.

13. The method of claim 5, further including the steps of:
parsing information from a given user-assessment; and
modifying a given member-assessment based upon the parsed information.

14. A system for responding to referral-requests, the system comprising:
a database of member-assessments, wherein the member-assessments are provided to the system from a plurality of members of a trusted network;
an input device that receives a referral-request from a given member of the trusted network;
a referral module that creates a trusted-referral using at least a portion of the referral-request and at least a portion of at least one member-assessment; and
an output device that provides the trusted-referral to the given member of the trusted network.

15. The system of claim 14, further including:
a management module that provides the members of the trusted network with compensation for providing user-assessments.

16. The system of claim 15, wherein the management module is configured to provide compensation only to those members that provided at least one recommendation used by the aggregator module.

17. The system of claim 15, wherein the input device receives a message from a particular member of the trusted network, the message including one user-assessment, and wherein the management module is configured to provide compensation to a particular member of the trusted network in response to receiving the one user-assessment.

18. The system of claim 14, further including
an aggregator module that creates a trusted network assessment using the database of member-assessments.

19. The system of claim 18, wherein the aggregator module is configured to create the trusted network assessment using member-assessments from only a subset of the members of the trusted network, wherein the number of members in the subset of the trusted network is less than the total number of members in the trusted network.

20. The system of claim 19, wherein the aggregator module is configured to exclude the given member from the subset of members of the trusted network.

21. The system of claim 19, wherein the input device receives a member-restrictor, and wherein the aggregator module is configured to use the member-restrictor to determine the subset of the members of the trusted network.

22. The system of claim 14, wherein the aggregation module is configured to apply weight factors to the member-assessments used to create the trusted network recommendation.

23. The system of claim 22, wherein the aggregation module is configured to use at least one weight factor provided by the given member.
